(19) United States
(12) Patent Application Publication
(10) Pub. No.: US 2017/0266948 A1
(43) Pub. Date: Sep. 21, 2017

(54) MODULAR SQUEEGEE HEAD APPARATUS FOR PRINTING MATERIALS

(71) Applicant: Intel Corporation, Santa Clara, CA (US)

(72) Inventors: Joshua D. Heppner, Chandler, AZ (US); Shawna M. Liff, Gilbert, AZ (US); Eric J. Li, Chandler, AZ (US); Anna M. Prakash, Chandler, AZ (US)

(21) Appl. No.: 15/072,285

(22) Filed: Mar. 16, 2016

(51) Int. Cl. B41F 15/18; B41F 15/44

(52) U.S. Cl. CPC B41F 15/18; B41F 15/44

(57) ABSTRACT

Described is an apparatus which comprises: a squeegee head which is operable to drop a material; and a vacuum manifold attachable to the squeegee head, wherein the vacuum manifold is operable to create a vacuum in a space prior to the squeegee head is to drop the material.

### BACKGROUND

Applying materials, particularly specialty materials to electronic packaging, or filling high aspect ratio features void free can be a slow, serial process leveraging multiple tool sets and significant factory floor space.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates an equipment for printing material in a vacuum chamber.

FIGS. 2A-C illustrate snapshots of a modular squeegee with an attachable vacuum manifold which together are used to print material, in accordance with some embodiments of the disclosure.

FIG. 2D illustrates a top view of a cross-section of the printing apparatus of FIG. 2C, in accordance with some embodiments of the disclosure.

FIGS. 3A-D illustrate snapshots of a modular squeegee with an attachable vacuum manifold and a curing apparatus which together are used to print material, in accordance with some embodiments of the disclosure.

FIGS. 4A-D illustrate snapshots of a modular squeegee with an attachable vacuum manifold and a curing apparatus which together are used to print material, in accordance with some embodiments of the disclosure.

FIG. 5 illustrates an apparatus with multi-ink squeegees with an attachable vacuum manifold and a curing apparatus which together are used to print material, in accordance with some embodiments of the disclosure.

FIG. 6 illustrates cross-sections of multiple dies coupled via solders formed using the printing apparatus, according to some embodiments of the disclosure.

FIG. 7 illustrates a flowchart of high throughput stencil printing using the printing tool, according to some embodiments of the disclosure.

FIG. 8 illustrates a flowchart of monitoring and controlling the printing apparatus, according to some embodiments of the disclosure.

FIG. 9 illustrates a portion of a printing tool with machine-readable storage media having instructions that when executed cause the printing tool to vacuum, print, and cure the material onto a target object, according to some embodiments of the disclosure.

FIG. 10 illustrates a smart device or a computer system or a SoC (System-on-Chip) which is packaged using the apparatus having the modular squeegee with an attachable vacuum manifold and a curing tool, according to some embodiments.

### DETAILED DESCRIPTION

As strip or panel size grows and the number of units per panel increases, applying or printing materials to electronic packaging, or filling high aspect ratio features void free becomes even slower. Take for example the process of underfill dispensing versus solder paste printing. The underfill dispensing process must align and dispense at each unit, or in the case of a bank of dispense nozzles the array must align and dispense at each array of units. In contrast during the printing process, a stencil is leveraged to mask off the area where the material is not wanted and then the material is spread via a squeegee across the area and into the apertures of the stencil. Dispensing of printing process has been limited to room temperature. Thereafter, subsequent vacuum processes and heating steps (e.g., reflow, or irradiation processes) have taken place at subsequent phases after printing and often inside different equipment modules.

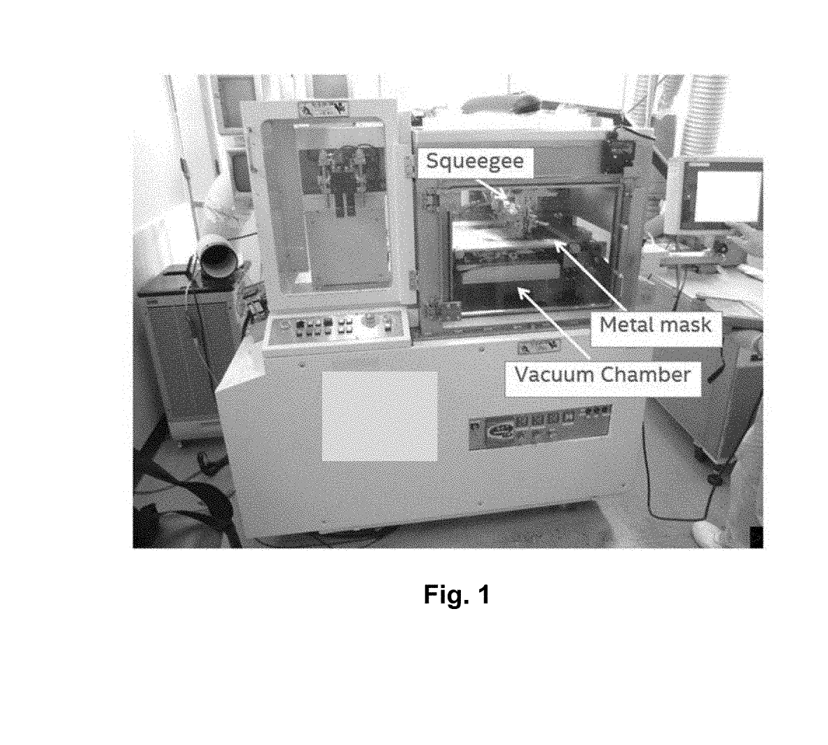

Current vacuum enabled print solutions, such as tool equipment 100 shown in FIG. 1, require the printing process is performed inside the chamber. Here, a vacuum is pulled first followed by material printing inside the chamber. Sometimes the chamber is backfilled with air again to help to push the printed material down and then vacuumed again followed by additional printing. This process can be repeated multiple times. Tool equipment 100 is a large setup including a vacuum generator, vacuum manifold, vacuum chamber, and tools for printing the material using metal mask on a target object (e.g., die package). The time for vacuum pump down and release of the entire inner tool environment is significant and significantly slows the throughput time of any product.

Various embodiments describe a printing apparatus for high throughput printing that integrates vacuum into the print head. In some embodiments, once vacuum is enabled and material is printed, a curing apparatus is used to cure the printed materials. For example, a bank of Light Emitting Diodes (LEDs) for Ultra-violet (UV) or Infra-Red (IR) stimulus, is used as a curing apparatus. In some embodiments, a vacuum manifold is provided which is attachable to a squeegee head, where the vacuum manifold is operable to create a vacuum in a space prior to the squeegee head is to drop the printing material to a target space. In some embodiments, a method is provided which comprises: attaching a vacuum manifold to a squeegee head; vacuuming a portion of a stencil using the vacuum manifold; and dropping a material by the squeegee head onto the portion of the stencil after vacuuming the portion of the stencil. In some embodiments, a machine readable storage media is provided having one or more instructions that when executed cause a machine to perform an operation according to the method described above.

In some embodiments, two vacuum modules or manifolds are integrated with the squeegee head or print module. By integrating two vacuum modules before and after a print module, it may be possible to dispense and print radical-propagated UV cure-able materials that have their crosslinking inhibited by the presence of oxygen or other oxygen sensitive (e.g., rate-limited materials). In some embodiments, a curing apparatus is added to cure the printed material. For example, inks or print materials such as copper oxide are coated with an organic coating that upon UV irradiation from the curing apparatus breaks the organic into an acid component that fluxes the oxide and facilitated fusing of the pure copper ink.

The various modules (e.g., vacuum modules, squeegee head, curing apparatus, etc.) are separate modules that can be attached to each other to perform a wide variety of functions (e.g., cleaning, printing, and curing) in one apparatus, in accordance with some embodiments. This provides a mechanism to dispense an entirely new class of materials utilizing low-cost, high throughput printing equipment in a normal ambient or clean room environment.

The modular printing apparatus of various embodiments enables high aspect ratio via fill and printing of novel materials. The modular printing apparatus of various embodiments cures previously dispensed materials (e.g., radical-based UV cured materials), and reduces throughput times and packaging costs by providing vacuum environment over a small volume. The modular printing apparatus of various embodiments integrates a tri-fold system (e.g., a system for vacuuming, printing, and curing) into a custom module that could be leveraged on any printing tool.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level. The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C). The terms “left,” “right,” “front,” “back,” “top,” “bottom,” “over,” “under,” and the like in the description and in the claims, if any, are used for descriptive purposes and not necessarily for describing permanent relative positions.

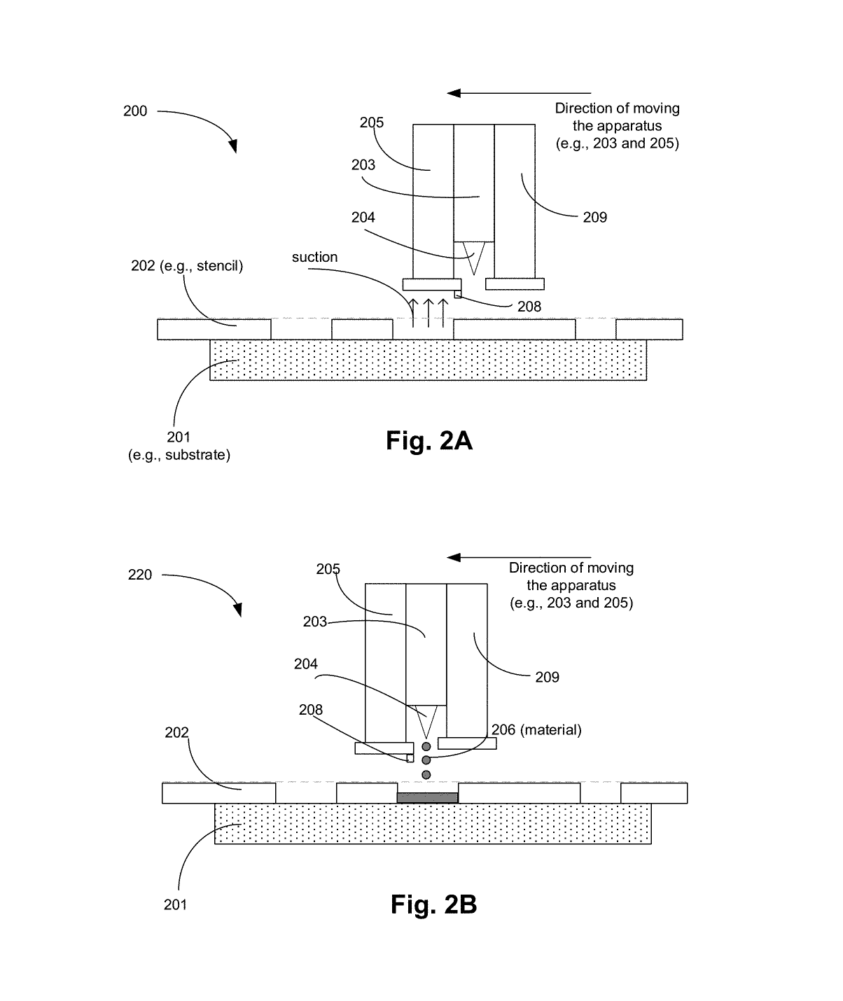

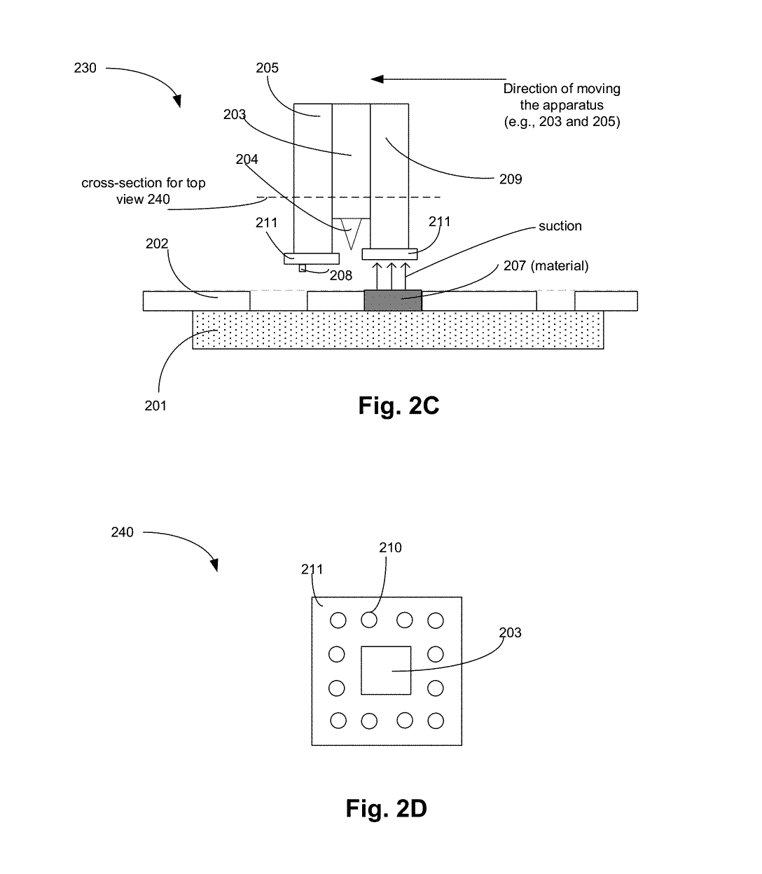

FIGS. 2A-C illustrate snapshots 200, 220, and 230, respectively, with an apparatus having a modular squeegee with an attachable vacuum manifold which together are used to print material, in accordance with some embodiments of the disclosure. Here, substrate 201 (e.g., wafer, substrate or laminate of a printed circuit board) is illustrated as a target object on which a material is to be deposited in a particular pattern defined by stencil 202. However, the printing apparatus of various embodiments can be used in a wide variety of cases. For example, the printing apparatus of various embodiments can be used for printing conductive paste. In another example, the printing apparatus of the various embodiments can be used for printing solder paste that is used for forming solder balls associated with a processor package.

In some embodiments, the apparatus of the printing tool comprises a squeegee head 203 having nozzle 204, and vacuum manifold 205 which is attachable to squeegee head 203. So as not to obscure the embodiments of the disclosure, a simplified version of squeegee head 203 is shown. A squeegee system may include a squeegee blade (not shown) which is used to push the to-be printed material (e.g., solder paste) on stencil 202 so that the material pushes into the apertures of stencil 202. In some embodiments, the squeegee blade is integrated in to nozzle 204 to push the material into the apertures of stencil 202.

In some embodiments, vacuum manifold 205 is coupled via a hose to a vacuum cleaning motor system. In some embodiments, vacuum system includes a fan, an electric motor, and housing to exhaust the sucked air. The vacuum system may be implemented using any known suitable vacuum pump technology. In some embodiments, a cyropump (or cryogenic pump) with zeolite chamber is used to reduce vibrations caused by the vacuum motor. In some embodiments, the suction power of vacuum manifold 205 is programmable. In some embodiments, the operations (e.g., suction power, turn-on time, turn-off time, etc.) of vacuum manifold 205 is controllable by a software (e.g., instructions stored on a machine-readable medium) or hardware module.

In some embodiments, thermocouples and or photo-detectors (collectively shown as 208) may be added to the printing apparatus to act as a monitor and method for feedback to the equipment triggering maintenance, excursion, or within process flags to a software process-control system. While the location of 208 is shown coupled to vacuum manifold 205, it can be placed at any suitable location to properly monitor the printing process (e.g., detect malfunctions, quality of material deposition and void removal, etc.).

In some embodiments, vacuum manifold 205 can be attached on either sides of squeegee head 203. Here, the direction of motion of the apparatus is indicated by the direction of motion of the arrow. When vacuum manifold 205 is attached ahead of squeegee head 203, then vacuum manifold 205 cleans out debris and air in deep cavities enabling efficient back-fill. In some embodiments, another vacuum manifold 209 is provided which is attached after squeegee head 203. In one such embodiments, vacuum manifold 209 enables void removal in the as deposited material or assurance of an oxygen free environment for materials with gas-species sensitivity.

The vacuum chamber of equipment of FIG. 1 may have a semi-automatic vacuum injection head that pulls vacuum while a nearby pressurized solder injection head pushes the material into the voided cavities and then a subsequent pressurized environment is leveraged for complete filling. In that case, a subsequent squeegee head then spreads the excess material and scrapes it away. The method of printing material on a target object by an equipment such as the one shown in FIG. 1 is much more complex than the printing apparatus of the various embodiments.

The apparatuses described with reference to FIGS. 2-5 apply a subsequent vacuum action and/or added curing mechanism for activating or stimulating curing of the printed material. Referring back to FIGS. 2A-C, in some embodiments, the vacuuming process is applied prior to filling of the material and also post filling of the material. In some embodiments, vacuum manifolds 205 and 209 are integrated with the print or squeegee head 203 for fast processing in an ultra-small volumetric environment.

The printing apparatus of some embodiments enable the addition of ultraviolet and infrared stimuli in gas-species limited environments. In some embodiments, a gas-species limited environment may not be needed to enable the curing of the materials. Existing printing solutions are not easily integratable with other tools and require removal of packages, strip, wafer or panel from a tool then subsequent processing in either a vacuum oven, reflow oven or ultraviolet/infrared irradiator. This significantly slows throughput and requires significant capital investment and floor space. Furthermore the environment between print and stimulus cannot be well controlled. These problems are solved by the printing apparatus of various embodiments.

In some embodiments, the addition of integrated vacuum modules 205/209 enable void removal without impact to run rate. As such, cavities in stencil 202 and package can be evacuated allowing the material to transfer better and reduce voids at the interface. In some embodiments, adding vacuum manifold 209 post print aids in the paste printing and compaction through stencils with small apertures, (e.g., 01005s, 008004s, etc. which are passive form factors).

Snapshot 200 illustrates the vacuuming by vacuum manifold 205 of a stencil cavity so that printing material can be deposited without voids on substrates 201, in accordance with some embodiments. Snapshot 220 illustrates the post vacuuming process of printing a material 206 via nozzle 204 attached to squeegee head 203, in accordance with some embodiments. Snapshot 230 illustrates post printing process of vacuuming again by vacuum manifold 209, in accordance with some embodiments. The suction power of vacuum manifold 209 may be different from the suction power of vacuum manifold 205 because the functions of vacuum manifold 209 is different than the function of vacuum manifold 205. For example, vacuum manifold 209 is used to eliminate any voids in the deposited material 207 without sucking material 207 out of its cavity while vacuum manifold 205 is used to create a vacuum for depositing material 206. In some embodiments, vacuum manifold 209 includes atmospheric pressure in addition to vacuum.

In some embodiments, cavities below the stencil too can be filled (e.g., like the area under a die when the capillary underfill is deposited at the die edges) and the rate at which the material is spread and filled can be controlled by the pressure to vacuum ratio and the speed at which the head is moved across the stencil. In some embodiments, vacuum manifold 209 is operable to compact material 207 in the cavities. In some embodiments, vacuum manifolds 205/209 create a pressure drop, for example, of up to 20 kPa (kilopascal). In some embodiments, cycling to 130 Pa of vacuum pressure is sufficient, and vacuum manifolds 205/209 can be programmed to keep the vacuum pressure at the same levels or slightly different levels depending on the flow rate designed. In some embodiments, vacuum produced by vacuum manifolds 205/209 can assist with printing materials in small apertures where stencils cannot be used because of their size.

In some embodiments, vacuum manifold 205 is attachable to squeegee head 203 by mechanisms such as slots, fastener system, hook, etc. In some embodiments, other components such as curing apparatus can also be attached to squeegee head 203 and/or vacuum manifold 205 by mechanisms such as slots, fastener system, hook, etc. In some embodiments, the distance of vacuum manifold 205 from stencil 202 can be adjusted independent of squeegee head 203. For example, vacuum manifold 205 can be raised or lowered relative to squeegee head 203. In some embodiments, the raising or lowering of vacuum manifold 205 can be done by software (e.g., instructions stored on a machine-readable medium) or hardware module. In some embodiments, a motorized connection exists between squeegee head 203 and vacuum manifold 205 to control relative height in real time, or during the process of vacuuming/printing, etc.

In some embodiments, the surface transfer vacuum to the stencil may use multiple mechanisms to enable a uniform vacuum pressure. For example, slots, holes, multiple arrays, and other geometries may be used to enable efficient transfer of vacuum by vacuum manifolds 205/209. In some embodiments, for better control of the vacuum boundary, the vacuum transfer may be wrapped around the edges of the squeegee system. As such, in one example, the region of interest obtains the required vacuum pressures. In some embodiments, an array of vacuum holes 210 are wrapped around squeegee head 203, as shown in FIG. 2D by top view 240 of a cross-section of the printing apparatus. In some embodiments vacuum holes 210 are formed in a plate 211 attached to vacuum manifolds 205/209. These vacuum holes 210 are used to transfer air sucked by vacuum manifolds 205/209, in accordance with some embodiments. In some embodiments, vacuum holes 210 are positioned merely in the leading edge of the system.

In some embodiments, squeegee head 203 selectively drops material 206 on substrate 201. In some embodiments, substrate 201 is a processor die, and material 206 is a photoresist. In some embodiments, squeegee head 203 has a single nozzle 204 which moves along the surface of substrate 201 to drop resist material 206 between metal bumps (not shown). In some embodiments, the printing apparatus is operable to move along ‘x’ and ‘y’ axis by a machine so that squeegee head 203 can drop resist material 206 between metal bumps according to a pattern. In some embodiments, a pattern is fed into the printing apparatus through a software. The pattern may indicate where vacuum manifold 205 should vacuum and where squeegee head 205 should drop resist material 206.

While some embodiments are illustrated with reference to a photoresist material being injected by squeegee head 203, other materials can be used (e.g., materials that can survive the process of plating and have thermal and chemical resistance for application of solders on the metal bumps). In some embodiments, printing material 206/207 is a solder resist material. In some embodiments, printing material 206/207 is a photoresist material which is an ink containing polymer material. In another example, printing material 206/207 is a thermally curable polymer, heat resistant resin, or Ultraviolet light (UV) curable polymer. In some embodiments, printing material 206/207 is polyimide. Other examples of print materials include: heat resistant material, phenolic resin, polyamide, poly (amideimide), polybenzoxazine, polybenzoxazole, polybenzimidazole, etc.

In some embodiments, print material 206/207 is a solder material. A variety of materials can be used for solder material. For example, silver, antimony, copper, tin, bismuth, indium, zinc, and their alloys can be used as solder material. Generally, lead-free solder materials are preferred. Other examples of solder material include: Cu₄Sn, Cu₆Sn₅, Cu₃Sn, Cu₃Sn₈ Cu₃In, Cu₉In₄, Ni₃Sn, Ni₃Sn₂, Ni₃Sn₄, NiSn₃, Ni₃In, NiIn, Ni₂In₃, Ni₃In₇, FeSn, FeSn₂, In₃Sn, InSn₄, In₃Pb, SbSn, BiPb₃, Ag₆Sn, Ag₃Sn, Ag₃In, AgIn₂ AusSn, AuSn AuSn₂, AuSn₄, Au₂Pb, AuPb₂, AuIn, AuIn₂, Pd₃Sn, Pd₂Sn, Pd₃Sn₂, PdSn, PdSn₂, PdSn₄ Pd₃In, Pd₂In, PdIn, Pd₂In₃, Pt₃Sn, Pt₂Sn, PtSn, Pt₂Sn₃, PtSn₂, PtSn₄, Pt₃Pb, PtPb, PtPb₄, Pt₂In₃, PtIn₂, Pt₃In₇, SAC (Tin Silver Copper) etc.

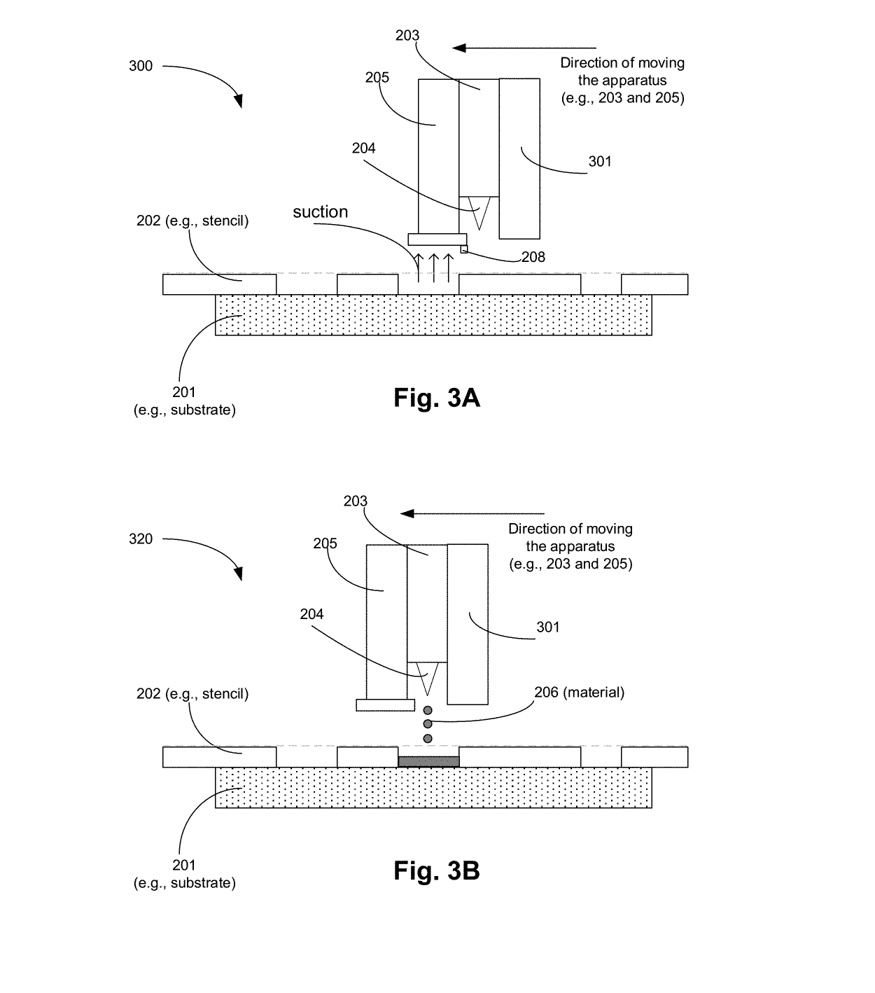

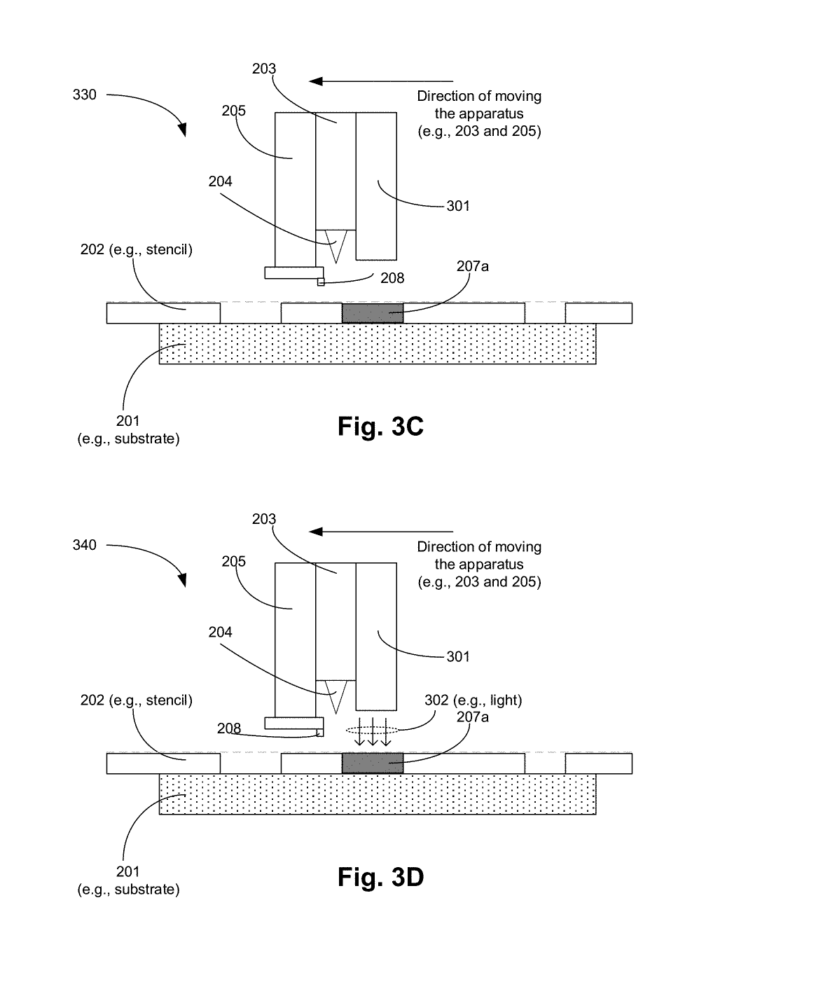

FIGS. 3A-D illustrate snapshots 300, 320, 330, and 340, respectively, of a modular squeegee with an attachable vacuum manifold and a curing apparatus which together are used to print material, in accordance with some embodiments of the disclosure. It is pointed out that those elements of FIGS. 3A-D having the same reference numbers (or names) as the elements of any other figure can operate or function in any manner similar to that described, but are not limited to such. So as not to obscure the embodiments, differences between the printing apparatus of FIGS. 2A-C and FIGS. 3A-D are described.

In some embodiments, in addition to or instead of vacuum manifold 209, curing apparatus 301 is attached to either squeegee head 203 or vacuum manifold 209. In some embodiments, curing apparatus 301 is attached to squeegee head 203 or vacuum manifold 209 by one of: mechanical fastener, snap fit mechanism, hook, and slot.

In some embodiments, curing apparatus 301 is a light source. For example, a UV/IR stimuli module is added to curing apparatus 301 which can enable printing of novel materials and control of flow direction and/or spreading and sticking of material to stencils 202. In some embodiments, the light source is a heat lamp. In some embodiments, the light source is a laser. In some embodiments, the light source is an array of light emitting diodes (LEDs). In some embodiments, the intensity and wavelength of the light can be controlled by software (e.g., instructions stored on a machine-readable medium) or hardware module. In some embodiments, the light source is a bank of UV, IR or wavelength specific LEDs. In some embodiments, the light source is a stimulus which can work to initiate cross-linking, break organic compounds to acids to initiate a chemical reaction such as oxide removal, or to control fluid/paste flow. For instance through pulsed irradiation ridges or waves, from curing apparatus 301, in material 207, subsequent material deposition, flow and or patterning can be controlled (e.g., prevented prevent or facilitated).

Here, snapshot 300 illustrates the vacuuming by vacuum manifold 205 of a stencil cavity so that printing material 206 (shown in FIG. 3B) can be deposited without voids on substrate 201, in accordance with some embodiments. Snapshot 320 illustrates the post vacuuming process of printing a material 206 via nozzle 204 attached to squeegee head 203, in accordance with some embodiments. Snapshot 330 illustrates setting of the post printing process of curing material 207. Here, curing apparatus 301 is brought above material 207 to cure the material. Snapshot 340 illustrates application of light 302 on material 207 to cure material 207, which after curing becomes material 207a. In some embodiments, prior to curing material 207, vacuum manifold 209 is used to vacuum the deposited material 207. For example, vacuum manifold 209 is used to eliminate any voids in the deposited material 207 without sucking material 207 out of its cavity while vacuum manifold 205 is used to create a vacuum for depositing material 206. After the voids are removed, apparatus 301 can cure the deposited material 207 in accordance with some embodiments.

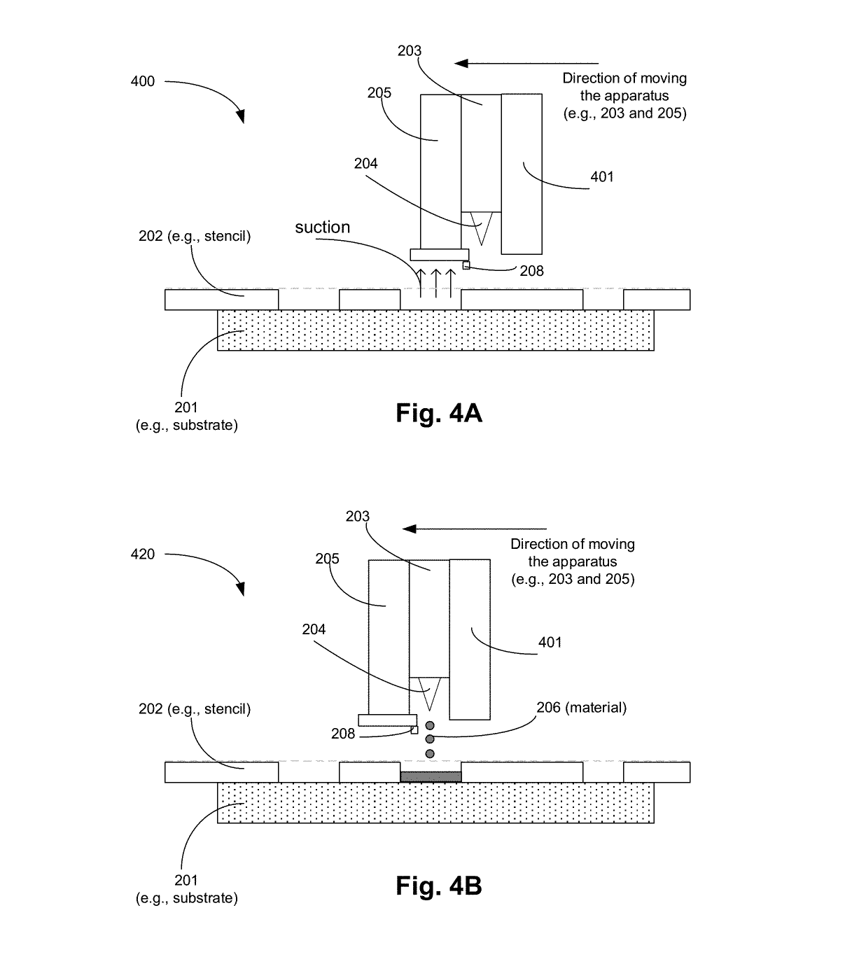

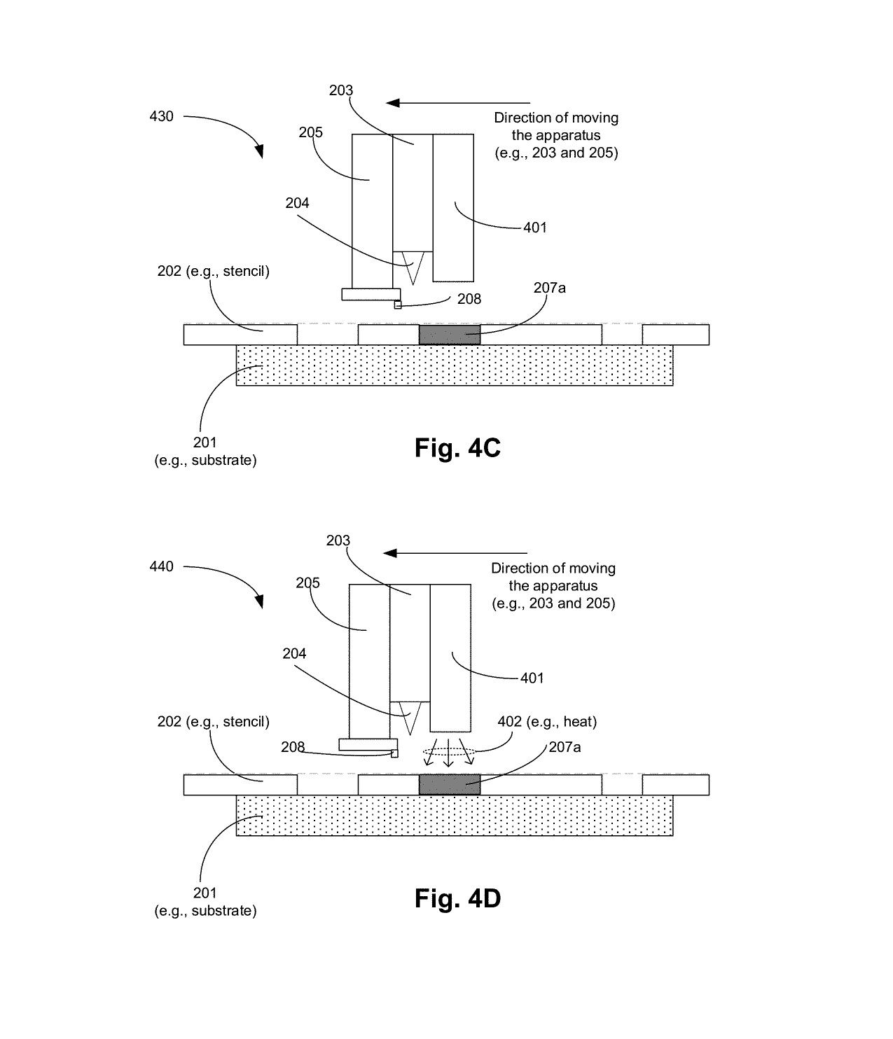

FIGS. 4A-D illustrate snapshots 400. 420. 430, and 440, respectively, of a modular squeegee with an attachable vacuum manifold and a curing apparatus which together are used to print material, in accordance with some embodiments of the disclosure. It is pointed out that those elements of FIGS. 4A-D having the same reference numbers (or names) as the elements of any other figure can operate or function in any manner similar to that described, but are not limited to such. So as not to obscure the embodiments, differences between the printing apparatus of FIGS. 3A-D and FIGS. 4A-D are described.

Here curing apparatus 401 is used instead of curing apparatus 301. In some embodiments, curing apparatus 401 is a heating apparatus/source (e.g., a heat lamp) with programmable heat 402 (as shown in FIG. 4D). In some embodiments, the heat source is to raise temperature of the dropped material to cure material 207. In some embodiments, apparatus 401 is integrated into apparatus 301. As such, apparatus 301 can provide light and heat curing capabilities, in accordance with some embodiments.

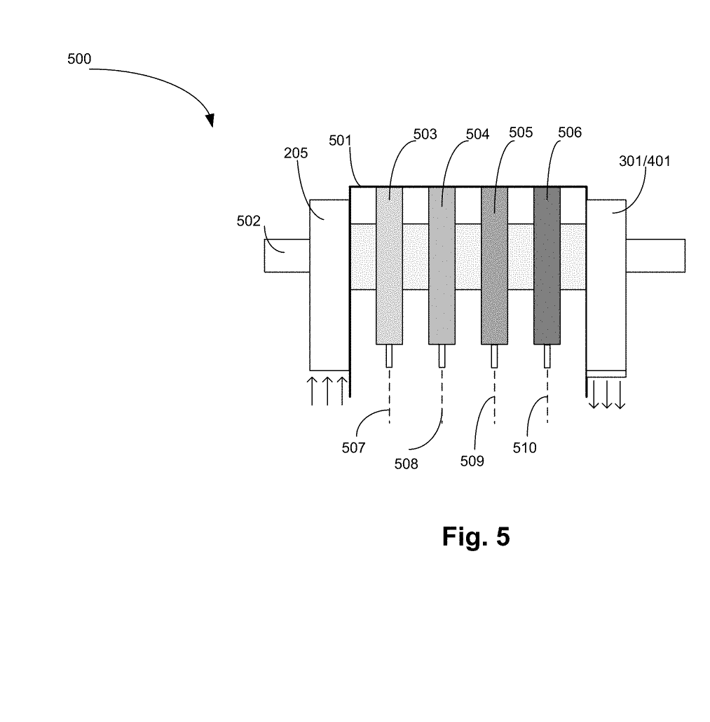

FIG. 5 illustrates apparatus 500 with multi-ink squeegees with an attachable vacuum manifold and a curing apparatus which together are used to print material, in accordance with some embodiments of the disclosure. It is pointed out that those elements of FIG. 5 having the same reference numbers (or names) as the elements of any other figure can operate or function in any manner similar to that described, but are not limited to such.

Compared to the printing apparatus of FIGS. 2-4, here, squeegee head 203 is replaced with a bank of print heads or array of dispense nozzles to provide a vacuous environment, for example, one void of oxygen species and a follow on module 301/401 integrated for UV/IR, heat, or other wavelength specific stimulus. In some embodiments, housing 501 is provided which contains a band of print heads 503, 504, 505, and 506. Any number print heads may be used in housing 501. In some embodiments, a fastener ledge 502 is provided to hold vacuum manifold 205, housing 501, and curing apparatus 301/401. The apparatus of FIG. 5 allows for printing multiple printing materials 507-510 on to a target object. In some embodiments, instead of curing apparatus 301/401, another vacuum manifold 209 is attached to housing 501. In some embodiments, curing apparatus 301/401 is attached to vacuum manifold 209.

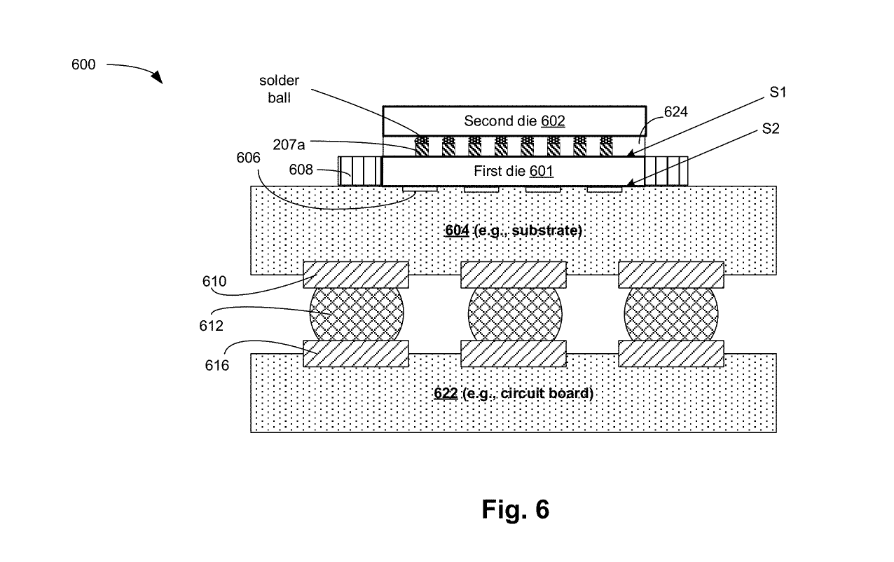

FIG. 6 illustrates cross-sections of multiple dies coupled via solders formed using printing apparatus, according to some embodiments of the disclosure.

In some embodiments, cross-sectional view 600 is of an integrated circuit (IC) package assembly, in accordance with various embodiments. In some embodiments, IC package assembly may include First die 601, package substrate 604 (or 201), and circuit board 622. IC package assembly of cross-sectional view 600 is one example of a stacked die configuration in which First die 601 is coupled to package substrate 604, and Second die 602 is coupled with First die 601, in accordance with some embodiments.

In some embodiments, First die 601 may have a first side S1 and a second side S2 opposite to the first side S1. In some embodiments, first side S1 may be the side of the die commonly referred to as the “inactive” or “back” side of the die. In some embodiments, second side S2 may include one or more transistors, and may be the side of the die commonly referred to as the “active” or “front” side of the die. In some embodiments, Second side S2 of First die 601 may include one or more electrical routing features 606. In some embodiments, Second die 602 may include an “active” or “front” side with one or more electrical routing features 606. In some embodiments, electrical routing features 606 may be bond pads (e.g., formed from a combination of metal bumps and solder balls).

In some embodiments, Second die 602 may be coupled to First die 601 in a front-to-back configuration (e.g., the “front” or “active” side of Second die 602 is coupled to the “back” or “inactive” side S1 of First die 601). In some embodiments, dies may be coupled with one another in a front-to-front, back-to-back, or side-to-side arrangement. In some embodiments, one or more additional dies may be coupled with First die 601, Second die 602, and/or with package substrate 604. Other embodiments may lack Second die 602. In some embodiments, First die 601 may include one or more through-silicon vias (TSVs).

In some embodiments, Second die 602 is coupled to First die 601 by die interconnects formed from combination of bumps and solder balls. In some embodiments, inter-die interconnects may be solder bumps, copper pillars, or other electrically conductive features. In some embodiments, copper pillars are formed by the printer apparatus of the various embodiments as described with reference to FIGS. 2-5. Referring back to FIG. 6, in some embodiments, an interface layer 624 may be provided between First die 601 and Second die 602. In some embodiments, interface layer 624 may be, or may include, a layer of under-fill, adhesive, dielectric, or other material. In some embodiments, interface layer 624 may serve various functions, such as providing mechanical strength, conductivity, heat dissipation, or adhesion.

In some embodiments, First die 601 and Second die 602 may be single dies. In other embodiments, First die 601 and/or Second die 602 may include two or more dies. For example, in some embodiments First die 601 and/or Second die 602 may be a wafer (or portion of a wafer) having two or more dies formed on it. In some embodiments, First die 601 and/or Second die 602 includes two or more dies embedded in an encapsulant. In some embodiments, the two or more dies are arranged side-by-side, vertically stacked, or positioned in any other suitable arrangement. In some embodiments, the IC package assembly may include, for example, combinations of flip-chip and wire-bonding techniques, interposers, multi-chip package configurations including system-on-chip (SoC) and/or package-on-package (PoP) configurations to route electrical signals.

In some embodiments, First die 601 and/or Second die 602 may be a primary logic die. In some embodiments, First die 601 and/or Second die 602 may be configured to function as memory, an application specific circuit (ASIC), a processor, or some combination of such functions. For example, First die 601 may include a processor and Second die 602 may include memory. In some embodiments, one or both of First die 601 and Second die 602 may be embedded in encapsulant 608. In some embodiments, encapsulant 608 can be any suitable material, such as epoxy-based build-up substrate, other dielectric/organic materials, resins, epoxies, polymer adhesives, silicones, acrylics, polyimides, cyanate esters, thermoplastics, and/or thermosets.

In some embodiments, First die 601 may be coupled to package substrate 404. In some embodiments, package substrate 604 may be a coreless substrate. For example, package substrate 604 may be a bumpless build-up layer (BBUL) assembly that includes a plurality of “bumpless” build-up layers. Here, the term “bumpless build-up layers” generally refers to layers of substrate and components embedded therein without the use of solder or other attaching means that may be considered “bumps.” However, the various embodiments are not limited to BBUL type connections between die and substrate, but can be used for any suitable flip chip substrates.

In some embodiments, the one or more build-up layers may have material properties that may be altered and/or optimized for reliability, warpage reduction, etc. In some embodiments, package substrate 604 may be composed of a polymer, ceramic, glass, or semiconductor material. In some embodiments, package substrate 604 may be a conventional cored substrate and/or an interposer.

In some embodiments, circuit board 622 may be a Printed Circuit Board (PCB) composed of an electrically insulative material such as an epoxy laminate. For example, circuit board 622 may include electrically insulating layers composed of materials such as, phenolic cotton paper materials (e.g., FR-1), cotton paper and epoxy materials (e.g., FR-3), woven glass materials that are laminated together using an epoxy resin (FR-4), glass/paper with epoxy resin (e.g., CEM-1), glass composite with epoxy resin, woven glass cloth with polytetrafluoroethylene (e.g., PTFE CCL), or other polytetrafluoroethylene-based prepreg material.

Structures such as traces, trenches, and vias (which are not shown here) may be formed through the electrically insulating layers to route the electrical signals of First die 601 through the circuit board 622. Circuit board 622 may be composed of other suitable materials in other embodiments. In some embodiments, circuit board 622 may include other electrical devices coupled to the circuit board that are configured to route electrical signals to or from First die 601 through circuit board 622. In some embodiments, circuit board 622 may be a motherboard.

In some embodiments, a first side of package substrate 604 is coupled to second surface S2 and/or electrical routing features 606 of First die 601. In some embodiments, a second opposite side of package substrate 604 is coupled to circuit board 622 by package interconnects 612. In some embodiments, package interconnects 612 are formed using the printing apparatus described with reference to FIGS. 2-5. Referring back to FIG. 6, in some embodiments, package interconnects 612 may couple electrical routing features 610 disposed on the second side of package substrate 604 to corresponding electrical routing features 616 on circuit board 622.

In some embodiments, package substrate 604 may have electrical routing features formed therein to route electrical signals between First die 601 (and/or the Second die 602) and circuit board 622 and/or other electrical components external to the IC package assembly. In some embodiments, package interconnects 612 and die interconnects 606 include any of a wide variety of suitable structures and/or materials including, for example, bumps, pillars or balls formed using metals, alloys, solderable material, or their combinations. In some embodiments, electrical routing features 610 may be arranged in a ball grid array (“BGA”) or other configuration.

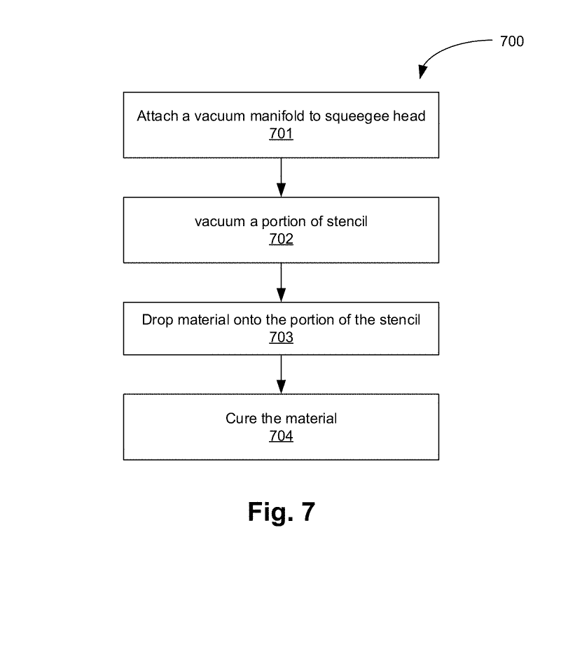

FIG. 7 illustrates flowchart 700 of high throughput stencil printing using the printing tool, according to some embodiments of the disclosure. It is pointed out that those elements of FIG. 7 having the same reference numbers (or names) as the elements of any other figure can operate or function in any manner similar to that described, but are not limited to such.

Although the blocks in the flowchart with reference to FIG. 7 are shown in a particular order, the order of the actions can be modified. Thus, the illustrated embodiments can be performed in a different order, and some actions/blocks may be performed in parallel. Some of the blocks and/or operations listed in FIG. 7 are optional in accordance with certain embodiments. The numbering of the blocks presented is for the sake of clarity and is not intended to prescribe an order of operations in which the various blocks must occur. Additionally, operations from the various flows may be utilized in a variety of combinations.

At block 701, vacuum manifold(s) 205/209 is attached to squeegee head 203 as described with reference to FIGS. 2A-C. The height of vacuum manifold(s) 205/209 may be adjusted relative to stencil 202 to achieve the optimal suction efficiency. At block 702, vacuum manifold 205 is enabled and turned on to vacuum air from a cavity which is to be filled with printing material (e.g., resist). At block 703, the printing material 206 is dropped by squeegee head 203 on to a target object (e.g., cavity exposing substrate 201). The printed material 207 is then vacuumed again to remove any holes/voids from material 207. At block 704, curing apparatus 301/401 is enabled to cure material 207.

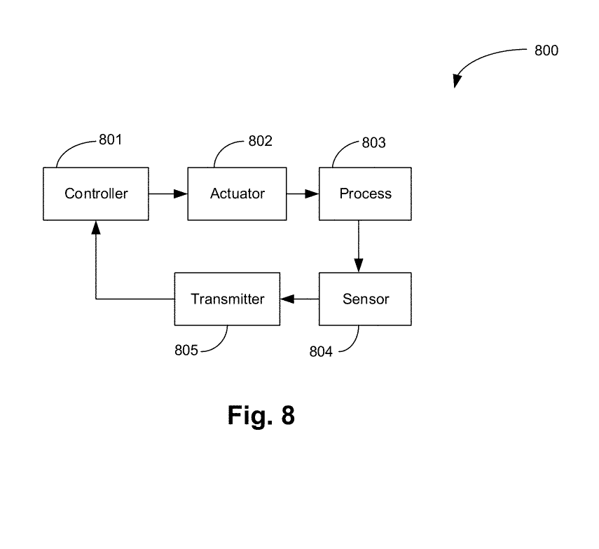

FIG. 8 illustrates flowchart 800 of monitoring and controlling the printing apparatus, according to some embodiments of the disclosure. In some embodiments, printing apparatus (as described with reference to FIGS. 2-5) includes a controller 801, actuator 802, one or more sensors (e.g., 208), and transmitter 805. In some embodiments, controller 801 is controllable by software or hardware, and is used to manage the printing process. For example, controller 801 instructs curing apparatus 301/401 when to turn on and off. In some embodiments, after material 206 is deposited, and is ready to be cured, controller 801 instructs curing apparatus 301/401 to turn on. For example, light and/or heat is provided to material 207. As such curing process 803 begins. After curing completes, one or more sensors 804 such as thermocouples and/or photodetectors records the wavelength, intensity, and/or temperature of material 207a. In some embodiments, the one or more sensors 208 relay that recorded information to transmitter 805, which transmits the recorded information wirelessly or by wired means to controller 801. In some embodiments, controller 801 evaluates the recorded information and adjusts wavelength, intensity, and/or temperature as needed to cure material 207.

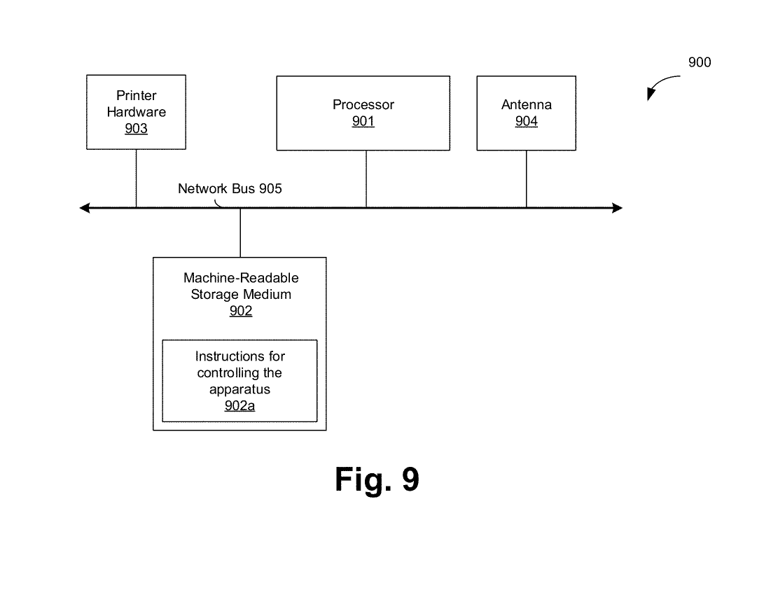

FIG. 9 illustrates portion 900 of a printing tool with machine-readable storage media having instructions that when executed cause the printing tool to vacuum, print, and cure the material on to a target object, according to some embodiments of the disclosure. It is pointed out that those elements of FIG. 9 having the same reference numbers (or names) as the elements of any other figure can operate or function in any manner similar to that described, but are not limited to such.

In some embodiments, portion 900 comprises Processor 901 (e.g., a Digital Signal Processor (DSP), an Application Specific Integrated Circuit (ASCI), a general purpose Central Processing Unit (CPU), or a low power logic executing flowchart 700, etc.), Machine-Readable Storage media 902 (also referred to as tangible machine readable medium), printing apparatus 903 (e.g., squeegee head 203, vacuum manifolds 205/209, curing apparatus 301/401, and hardware that can execute instructions) Antenna 904, and Network Bus 905.

Any suitable protocol may be used to implement Network Bus 905. In some embodiments, Machine-Readable Storage Media 902 includes Instructions 902a (also referred to as the program software code/instructions) for calculating or measuring distance and relative orientation of a device with reference to another device as described with reference to various embodiments and flowchart.

Program software code/instructions 902a associated with flowchart 700 and executed to implement embodiments of the disclosed subject matter may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software” or firmware embedded in processor. In some embodiments, the program software code/instructions associated with flowchart 700 are executed by printing tool.

Referring back to FIG. 9, in some embodiments, the program software code/instructions 902a associated with flowchart 700 are stored in a computer executable storage medium 902 and executed by Processor 901. Here, computer executable storage medium 902 is a tangible machine readable medium that can be used to store program software code/instructions and data that, when executed by a computing device, causes one or more processors (e.g., Processor 901) to perform a method(s) as may be recited in one or more accompanying claims directed to the disclosed subject matter.

The tangible machine readable medium 902 may include storage of the executable software program code/instructions 902a and data in various tangible locations, including for example ROM, volatile RAM, non-volatile memory and/or cache and/or other tangible memory as referenced in the present application. Portions of this program software code/instructions 902a and/or data may be stored in any one of these storage and memory devices. Further, the program software code/instructions can be obtained from other storage, including, e.g., through centralized servers or peer to peer networks and the like, including the Internet. Different portions of the software program code/instructions and data can be obtained at different times and in different communication sessions or in the same communication session.

The software program code/instructions 902a (associated with flowchart 700 and other embodiments) and data can be obtained in their entirety prior to the execution of a respective software program or application by the computing device. Alternatively, portions of the software program code/instructions 902a and data can be obtained dynamically, e.g., just in time, when needed for execution. Alternatively, some combination of these ways of obtaining the software program code/instructions 902a and data may occur, e.g., for different applications, components, programs, objects, modules, routines or other sequences of instructions or organization of sequences of instructions, by way of example. Thus, it is not required that the data and instructions be on a tangible machine readable medium in entirety at a particular instance of time.

Examples of tangible computer-readable media 902 include but are not limited to recordable and non-recordable type media such as volatile and non-volatile memory devices, read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs), etc.), among others. The software program code/instructions may be temporarily stored in digital tangible communication links while implementing electrical, optical, acoustical or other forms of propagating signals, such as carrier waves, infrared signals, digital signals, etc. through such tangible communication links.

In general, tangible machine readable medium 902 includes any tangible mechanism that provides (i.e., stores and/or transmits in digital form, e.g., data packets) information in a form accessible by a machine (i.e., a computing device), which may be included, e.g., in a communication device, a computing device, a network device, a personal digital assistant, a manufacturing tool, a mobile communication device, whether or not able to download and run applications and subsidized applications from the communication network, such as the Internet, e.g., an iPhone®, Galaxy®, Blackberry® Droid®, or the like, or any other device including a computing device. In one embodiment, processor-based system is in a form of or included within a PDA (personal digital assistant), a cellular phone, a notebook computer, a tablet, a game console, a set top box, an embedded system, a TV (television), a personal desktop computer, etc. Alternatively, the traditional communication applications and subsidized application(s) may be used in some embodiments of the disclosed subject matter.

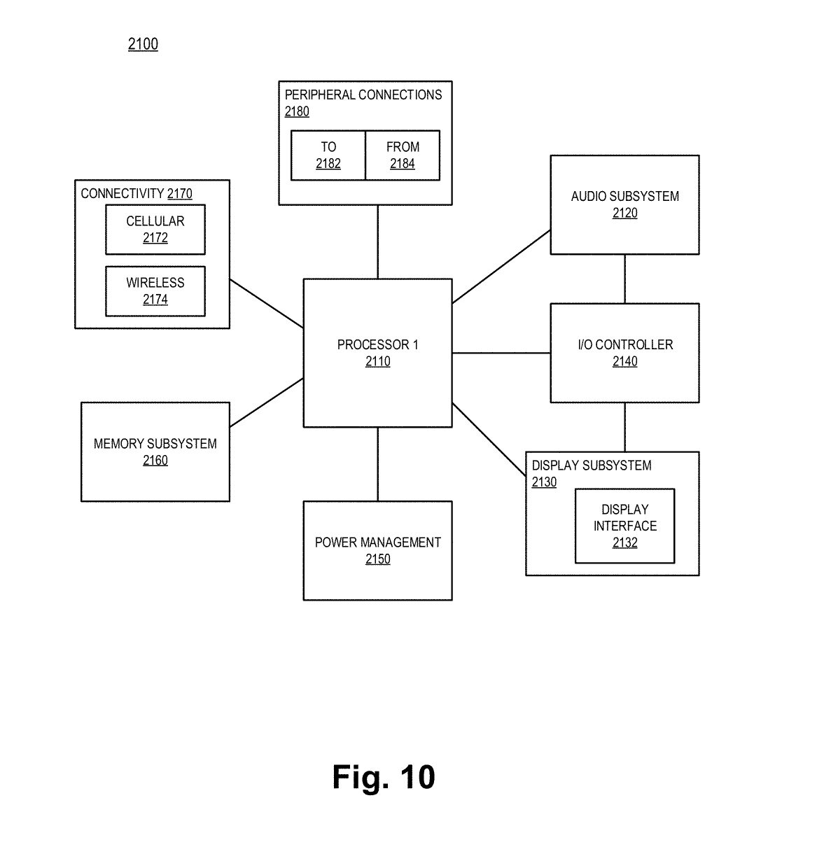

FIG. 10 illustrates a smart device or a computer system or a SoC (System-on-Chip) which is packaged using the apparatus having the modular squeegee with an attachable vacuum manifold and a curing tool, according to some embodiments. It is pointed out that those elements of FIG. 10 having the same reference numbers (or names) as the elements of any other figure can operate or function in any manner similar to that described, but are not limited to such.

For purposes of the embodiments, the transistors in various circuits and logic blocks described here are metal oxide semiconductor (MOS) transistors or their derivatives, where the MOS transistors include drain, source, gate, and bulk terminals. The transistors and/or the MOS transistor derivatives also include Tri-Gate and FinFET transistors, Gate All Around Cylindrical Transistors, Tunneling FET (TFET), Square Wire, or Rectangular Ribbon Transistors, ferroelectric FET (FeFETs), or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors-BJT PNP/NPN, BiCMOS, CMOS, etc., may be used without departing from the scope of the disclosure.

FIG. 10 illustrates a block diagram of an embodiment of a mobile device in which flat surface interface connectors could be used. In some embodiments, computing device 2100 represents a mobile computing device, such as a computing tablet, a mobile phone or smart-phone, a wireless-enabled e-reader, or other wireless mobile device. It will be understood that certain components are shown generally, and not all components of such a device are shown in computing device 2100.

In some embodiments, computing device 2100 includes a first processor 2110 (e.g., First die 601). The various embodiments of the present disclosure may also comprise a network interface within 2170 such as a wireless interface so that a system embodiment may be incorporated into a wireless device, for example, cell phone or personal digital assistant.

In one embodiment, processor 2110 (and/or another processor, e.g., Second die 602) can include one or more physical devices, such as microprocessors, application processors, microcontrollers, programmable logic devices, or other processing means. The processing operations performed by processor 2110 include the execution of an operating platform or operating system on which applications and/or device functions are executed. The processing operations include operations related to I/O (input/output) with a human user or with other devices, operations related to power management, and/or operations related to connecting the computing device 2100 to another device. The processing operations may also include operations related to audio I/O and/or display I/O.

In one embodiment, computing device 2100 includes audio subsystem 2120, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into computing device 2100, or connected to the computing device 2100. In one embodiment, a user interacts with the computing device 2100 by providing audio commands that are received and processed by processor 2110.

Display subsystem 2130 represents hardware (e.g., display devices) and software (e.g., drivers) components that provide a visual and/or tactile display for a user to interact with the computing device 2100. Display subsystem 2130 includes display interface 2132, which includes the particular screen or hardware device used to provide a display to a user. In one embodiment, display interface 2132 includes logic separate from processor 2110 to perform at least some processing related to the display. In one embodiment, display subsystem 2130 includes a touch screen (or touch pad) device that provides both output and input to a user.

I/O controller 2140 represents hardware devices and software components related to interaction with a user. I/O controller 2140 is operable to manage hardware that is part of audio subsystem 2120 and/or display subsystem 2130. Additionally, I/O controller 2140 illustrates a connection point for additional devices that connect to computing device 2100 through which a user might interact with the system. For example, devices that can be attached to the computing device 2100 might include microphone devices, speaker or stereo systems, video systems or other display devices, keyboard or keypad devices, or other I/O devices for use with specific applications such as card readers or other devices.

As mentioned above, I/O controller 2140 can interact with audio subsystem 2120 and/or display subsystem 2130. For example, input through a microphone or other audio device can provide input or commands for one or more applications or functions of the computing device 2100. Additionally, audio output can be provided instead of, or in addition to display output. In another example, if display subsystem 2130 includes a touch screen, the display device also acts as an input device, which can be at least partially managed by I/O controller 2140. There can also be additional buttons or switches on the computing device 2100 to provide I/O functions managed by I/O controller 2140.

In one embodiment, I/O controller 2140 manages devices such as accelerometers, cameras, light sensors or other environmental sensors, or other hardware that can be included in the computing device 2100. The input can be part of direct user interaction, as well as providing environmental input to the system to influence its operations (such as filtering for noise, adjusting displays for brightness detection, applying a flash for a camera, or other features).

In one embodiment, computing device 2100 includes power management 2150 that manages battery power usage, charging of the battery, and features related to power saving operation. Memory subsystem 2160 includes memory devices for storing information in computing device 2100. Memory can include nonvolatile (state does not change if power to the memory device is interrupted) and/or volatile (state is indeterminate if power to the memory device is interrupted) memory devices. Memory subsystem 2160 can store application data, user data, music, photos, documents, or other data, as well as system data (whether long-term or temporary) related to the execution of the applications and functions of the computing device 2100.

Elements of embodiments are also provided as a machine-readable medium (e.g., memory 2160) for storing the computer-executable instructions. The machine-readable medium (e.g., memory 2160) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

Connectivity 2170 includes hardware devices (e.g., wireless and/or wired connectors and communication hardware) and software components (e.g., drivers, protocol stacks) to enable the computing device 2100 to communicate with external devices. The computing device 2100 could be separate devices, such as other computing devices, wireless access points or base stations, as well as peripherals such as headsets, printers, or other devices.

Connectivity 2170 can include multiple different types of connectivity. To generalize, the computing device 2100 is illustrated with cellular connectivity 2172 and wireless connectivity 2174. Cellular connectivity 2172 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 2174 refers to wireless connectivity that is not cellular, and can include personal area networks (such as Bluetooth, Near Field, etc.), local area networks (such as Wi-Fi), and/or wide area networks (such as WiMax), or other wireless communication.

Peripheral connections 2190 include hardware interfaces and connectors, as well as software components (e.g., drivers, protocol stacks) to make peripheral connections. It will be understood that the computing device 2100 could both be a peripheral device (“to” 2182) to other computing devices, as well as have peripheral devices (“from” 2184) connected to it. The computing device 2100 commonly has a “docking” connector to connect to other computing devices for purposes such as managing (e.g., downloading and/or uploading, changing, synchronizing) content on computing device 2100. Additionally, a docking connector can allow computing device 2100 to connect to certain peripherals that allow the computing device 2100 to control content output, for example, to audiovisual or other systems.

In addition to a proprietary docking connector or other proprietary connection hardware, the computing device 2100 can make peripheral connections 2680 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

For example, an apparatus is provided which comprises: a squeegee head which is operable to drop a material; and a vacuum manifold attachable to the squeegee head, wherein the vacuum manifold is operable to create a vacuum in a space prior to the squeegee head is to drop the material. In some embodiments, the apparatus comprises: a light source attachable to the squeegee head. In some embodiments, the light source is to shine light on the dropped material to cure the material. In some embodiments, the light source is a laser. In some embodiments, the light source is one of ultraviolet or infrared light source.

In some embodiments, the apparatus comprises a heat source attachable to the squeegee head. In some embodiments, the heat source is to raise temperature of the dropped material to cure the material. In some embodiments, the vacuum manifold is operable to create a vacuum in a portion of a stencil which is exposed to a substrate or wafer. In some embodiments, the vacuum manifold is attachable to the squeegee head by one of: mechanical fastener, snap fit mechanism, hook, and slot.

In some embodiments, the vacuum manifold attachable is to surround the squeegee head. In some embodiments, the apparatus comprises a thermocouple sensor to monitor the vacuum manifold or squeegee head. In some embodiments, the apparatus comprises a photo-detector to monitor the vacuum manifold or squeegee head.

In another example, a method is provided which comprises: attaching a vacuum manifold to a squeegee head; vacuuming a cavity in a stencil using the vacuum manifold; and dropping a material by the squeegee head onto the cavity after vacuuming the cavity. In some embodiments, the method comprises curing the material after dropping the material. In some embodiments, curing the material comprises shining light on the dropped material. In some embodiments, curing the material comprises transmitting heat on to the dropped material.

In another example, a machine readable storage media is provided having one or more instructions that when executed cause a machine to perform an operation which comprises: attach a vacuum generator to a squeegee head; vacuum a cavity in a stencil using the vacuum generator; and drop a material by the squeegee head onto the cavity after vacuuming cavity. In some embodiments, the machine readable storage media has one or more instructions that when executed cause the machine to perform an operation which comprises cure the material after dropping the material. In some embodiments, the operation to cure the material comprises shining light on the dropped material. In some embodiments, the operation to cure the material comprises transmitting heat on to the dropped material.

In another example, an apparatus is provided which comprises: means for attaching a vacuum manifold to a squeegee head; means for vacuuming a cavity in a stencil using the vacuum manifold; and means for dropping a material by the squeegee head onto the cavity after vacuuming the cavity. In some embodiments, the apparatus comprises means for curing the material after dropping the material. In some embodiments, the means for curing the material comprises means for shining light on the dropped material. In some embodiments, the means for curing the material comprises means for transmitting heat on to the dropped material.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1. An apparatus comprising:
a squeegee head which is operable to drop a material; and
a vacuum manifold attachable to the squeegee head, wherein the vacuum manifold is operable to create a vacuum in a space prior to the squeegee head is to drop the material, wherein the vacuum manifold is attachable to the squeegee head such that the vacuum manifold wraps around the squeegee head to surround the squeegee head.

2. The apparatus of claim 1 comprises a light source attachable to the squeegee head.

3. The apparatus of claim 2, wherein the light source is to shine light on the dropped material to cure the material.

4. The apparatus of claim 2, wherein the light source is a laser.

5. The apparatus of claim 2, wherein the light source is one of ultraviolet or infrared light source.

6. The apparatus of claim 1 comprises a heat source attachable to the squeegee head.

7. The apparatus of claim 6, wherein the heat source is to raise temperature of the dropped material to cure the material.

8. The apparatus of claim 1, wherein the vacuum manifold is operable to create a vacuum in a portion of a stencil which is exposed to a substrate or wafer.

9. The apparatus of claim 1, wherein the vacuum manifold is attachable to the squeegee head by one of: mechanical fastener, snap fit mechanism, hook, and slot.

10. (canceled)

11. The apparatus of claim 1 comprises a thermocouple sensor to monitor the vacuum manifold or squeegee head.

12. The apparatus of claim 1 comprises a photo-detector to monitor the vacuum manifold or squeegee head.

13. A method comprising:
attaching a vacuum manifold to a squeegee head;
vacuuming a cavity in a stencil using the vacuum manifold; and
dropping a material by the squeegee head onto the cavity after vacuuming the cavity, wherein the vacuum manifold is attached to the squeegee head such that the vacuum manifold wraps around the squeegee head to surround the squeegee head

14. The method of claim 13 comprises curing the material after dropping the material.

15. The method of claim 13, wherein curing the material comprises shining light on the dropped material.

16. The method of claim 13, wherein curing the material comprises transmitting heat on to the dropped material.

17. Machine readable storage media having one or more instructions that when executed cause a machine to perform an operation which comprises:
attach a vacuum generator to a squeegee head;
vacuum a cavity in a stencil using the vacuum generator; and
drop a material by the squeegee head onto the cavity after vacuuming cavity, wherein the vacuum manifold is attached to the squeegee head such that the vacuum manifold wraps around the squeegee head to surround the squeegee head.

18. The machine readable storage media of claim 17 having one or more instructions that when executed cause the machine to perform an operation which comprises cure the material after dropping the material.

19. The machine readable storage media of claim 17 wherein the operation to cure the material comprises shining light on the dropped material.

20. The machine readable storage media of claim 17, wherein the operation to cure the material comprises transmitting heat on to the dropped material.
